(19) United States
(12) Patent Application Publication
(10) Pub. No.: US 2011/0178839 A1
(43) Pub. Date: Jul. 21, 2011

(54) METHOD AND SYSTEM FOR EVALUATING A CONSUMER PRODUCT BASED ON WEB-SEARCHABLE CRITERIA

(76) Inventor: Hosni I. Adra, Naperville, IL (US)

(21) Appl. No.: 13/009,739

(22) Filed: Jan. 19, 2011

Related U.S. Application Data
(60) Provisional application No. 61/296,842, filed on Jan. 20, 2010.

(51) Int. Cl. G06Q 10/00

(52) U.S. Cl. 705/7.29; 705/306

(57) ABSTRACT

A method is provided for generating a value of a product by aggregating product information collected from a plurality of sources in a networked computer system. The method determines appropriate indicators for the product, and collects information associated with the located products from one or more of the sources. The method further selects a set of data from the parsed information and curve-fits the set of data based on the predetermined parameters to generate the value of the product.

This patent application claims priority to U.S. Provisional Patent Application No. 61/296,842 filed on Jan. 20, 2010, which is incorporated herein by reference in its entirety.

### TECHNICAL FIELD

The present embodiments relate, in general, to methods and systems for evaluating consumer products and, more particularly, to a method and system for determining a value of a consumer product based on Web-searchable criteria and Web-accessible data.

### BACKGROUND OF THE INVENTION

One of the primary applications of the Internet or World Wide Web (WWW, hereafter referred to as Web), has been shopping, i.e. the purchase of goods and services, i.e. products. Virtually every major commercial “bricks and mortar” merchant, wholesaler and/or retailer, has established a Web site for the advertising, showcase and sale of their products. Further many manufacturers sell their products directly over the Web. As a result, a plurality of merchants virtually makes every one of their products available for purchase over the Web. This situation has increased the efficiency of markets by permitting shoppers or other merchants to readily compare products and terms of sale from many merchants without the need to travel physically to the merchant locations.

Taking also advantage of the inherent interconnectivity of the Web, the automotive marketplace has developed new ways to efficiently locate information about and determine a competitive market value of a vehicle. With a fast moving market and online competition, merchants constantly struggle to maintain a desirable inventory mix of products that provides maximum returns. Moreover, product pricing criteria change constantly and the ability to provide current and future competitive values of products is generally a tough task to attain.

Therefore, there exists an unfulfilled need for a way to seamlessly collect web-accessible data based on from a networked computer environment about a targeted product to thereby aggregate corresponding collected product information to generate not only a current market value of the product, but also trend future values of the product based on specific features, market forecasts and historical records.

### BRIEF SUMMARY OF THE INVENTION

The present invention is defined by the appended claims. This description summarizes some aspects of the present embodiments and should not be used to limit the claims.

The foregoing problems are solved and a technical advance is achieved by methods, systems and articles of manufacture consistent with the present invention, which efficiently locate information about and determine a competitive market value of a consumer product, such as a vehicle, based on Web-searchable criteria and Web-accessible data.

In accordance with methods consistent with the present invention, a method of generating a value of a product by aggregating product information collected from a plurality of sources in a networked computer system is provided. The method generates a value of a product by aggregating product information collected from a plurality of sources in a networked computer system is provided. The method determines appropriate indicators for the product, and collects information associated with the located products from one or more of the sources. The method further selects a set of data from the parsed information and curve-fits the set of data based on predetermined parameters to generate the value of the product.

In accordance with systems consistent with the present invention, an image processing system is provided. The system comprises a memory and a processing unit coupled to the memory wherein the processing unit is configured to execute the above noted method steps.

In accordance with articles of manufacture consistent with the present invention, there is provided a computer-readable medium containing a program adapted to cause a data processing system to execute the above-noted method steps. In this regard, the computer-readable medium may be a computer-readable medium, such as solid-state memory, magnetic memory such as a magnetic disk, optical memory such as an optical disk.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

FIG. 1 is a system diagram illustrating an embodiment of a computer networked system in accordance with the invention;

FIG. 2 is a block diagram schematically illustrating an embodiment of a system for evaluating a consumer product based on collected data in accordance with the invention;

FIG. 3 is a block diagram schematically illustrating an embodiment of a data analyzing and mining engine in accordance with the invention;

FIG. 4 is a block diagram schematically illustrating an embodiment of a pricing engine in accordance with the invention;

FIG. 5 is a graph illustrating the price of a vehicle as a function of selectable criteria in accordance with the invention;

FIG. 6 is a flow chart illustrating a method for evaluating current and future prices of vehicles in accordance with the invention; and

FIG. 7 is a block diagram of a computer system, such as a client computer or server, utilized in accordance with the present invention.

Illustrative and exemplary embodiments of the invention are described in further detail below with reference to and in conjunction with the figures.

### DETAILED DESCRIPTION OF THE DRAWINGS

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

With merchants, such as vehicle dealers, listing products on their Web sites thereby utilizing the Internet as a key selling store, a vehicle dealer may also rely on these Internet listings to track and evaluate a current market value or even market saturation of a specific vehicle. To effectively update vehicle values and market analyses according to a specific region, the vehicle information collected may be indexed based on geographical locations, such as within a specific region or distance range from the vehicle dealer, statewide, nationwide, or even world wide. Based on at least historical, seasonal, and future trends, the vehicle evaluation can be extrapolated from the collected data and generated analyses to derive a future value of the vehicle.

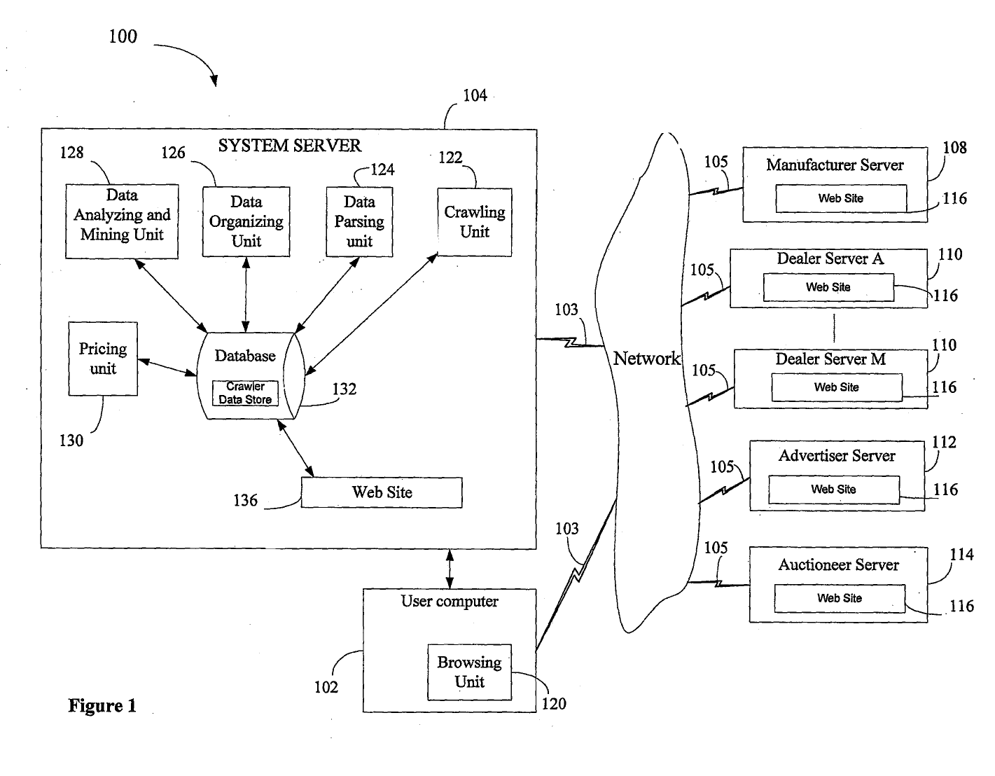

Turning now to the drawings, and particularly to FIG. 1, a functional diagram illustrates an embodiment of a computer networked system 100 in accordance with the invention. The computer networked system 100 includes a user computer 102, a system server 104, a manufacturer server 108, dealer servers A-M 110, an advertized server 112, and an auctioneer server 114. A network 106 serves as a communication channel, between the system server 104 and the manufacturer sever 108, the dealer servers A-M 110, the advertiser server 112, and the auctioneer server 114, through communication links 103 and 105. The network 106 may be the Internet, also referred to as the World Wide Web (the “Web”). The system server 104 may support or be part of a vehicle merchant, such as dealers, auctioneers, and the like. For the sake of simplicity, the system server 104 is considered hereafter to be utilized by a vehicle dealer.

The user computer 102 includes a browser unit 120. The system server 104 includes a crawling unit 122, a data parsing unit 124, a data organizing unit 126, a data analyzing and mining unit 128, a pricing unit 130, and a database 132. The system server 104 includes or may support a Web site 136. Similarly, each of the manufacturer server 108, the other dealer servers A through M 110, the advertized server 112, and the auctioneer server 114 includes or supports a corresponding Web site 116. For simplicity of discussion, the Web sites 116 and 136 are considered to be structured in a similar fashion while providing access to information, stored in a plurality of corresponding Web pages.

The communication links 103 and 105 may include Internet service providers (ISPs) (not shown). The servers 104 and 108-114 can be coupled to corresponding ISPs via conventional dial up connections using modems or through broadband connections such as Integrated Services Digital Networks (ISDNs), cable modems, or Digital Subscriber Line (DSL) connections.

Each of the system server 104, the manufacturer sever 108, the dealer servers A-M 110, the advertiser server 112 and the auctioneer server 114 may be configured to provide on-line advertizing and potentially shopping using server control applications, i.e. commerce software programs that enable product displays, and online ordering, among others. As stated above, these servers 104 and 108-114 have or support Web sites 116 and 136 that typically include Web pages stored in memory devices thereof as files in HTML format and/or other formats. In addition to links 103 and 105, the servers 104 and 108-114 can be linked together by various hardware communication links all running the standard Internet protocol suite, commonly known as transmission control protocol/Internet protocols (TCP/IP). Components of TCP/IP typically include an application-level protocol at the application layer known as the hypertext transfer protocol (HTTP). HTTP provides users access to files of various formats using a standard page description languages, such as hypertext markup language (HTML), extensible markup language (XML) and extensible hypertext markup language (XHTML).

Each of the system server 104, the manufacturer sever 108, other dealer servers A-M 110, advertiser server 112 and auctioneer server 114 includes viewing software applications or programs and HTTP that enable graphical user interfaces (GUI) to be used to communicate over the network 104. By making the Web pages accessible on an Internet Web server through HTML, XHTML, and interactive programming protocols, Web pages information is made accessible to viewers and to searches by search engines to gather information. A network path to a Web server is generally identified by a uniform resource locator (URL) and, typically any client/user computer or sever running a Web browser can access the Web server by using the URL. As such, for example, the browsing unit 120 can request a display of a Web page stored in the manufacturer server 108 by issuing a corresponding URL request through the network 104. In response to the received URL request identifying the Web page, the manufacturer server 108 can return the Web page to the system server 104 for download and/or for display on the user computer 102. Typically, Web pages are structured or configured to include both textual and graphical information. The textual information may also include hyper-text links that enable the user to be redirected to another URL over the network 106. As such, one task of a Web server is to respond to requests for Web pages communicated or issued by analyzing the content of the URL requests, determining an appropriate document to send in response, and returning it to the requester, which may be a server computer, a personal computer (desk or laptop), a notebook or a mobile device.

In addition to HTTP, a Web server may also utilize other known protocols such as the common gateway interface (CGI), Active Server Pages and Java, for information exchange. Further, Web servers are also capable of communicating using secure connection protocol, such as the secure sockets layer (SSL) and secure HTTP, over the same physical connection or communication channel, such as the network 104.

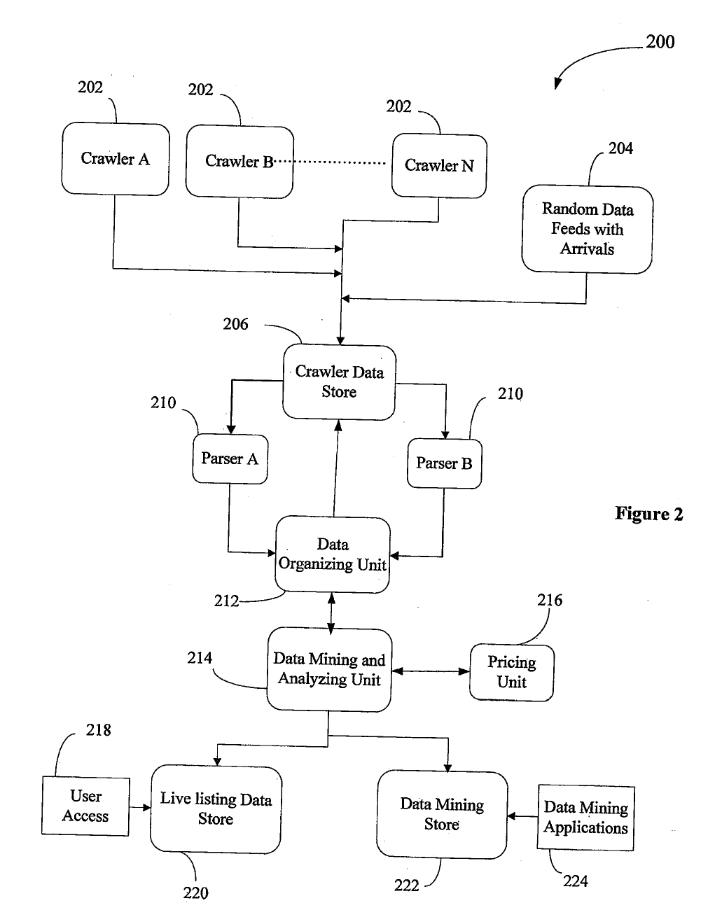

Now referring to FIG. 2, a functional diagram 200 illustrates an embodiment of a system for locating and evaluating a consumer product based on collected data. As known and appreciated in the art, there are presently millions of Web pages with various content. Tools have been developed to allow the user to search Web sites to obtain or access the various Web pages having the various content of interest. One way to locate the desired Web pages is to use search engine which are configured to search for Web pages having a particular keyword or key words. Search engines typically have three components: a crawler (such as a robot, bot or automated site searcher), an index, and a software program which presents the results of the search to the user and/or provides the search results to a database or another program. The crawler automatically “crawls” from Web server to Web server and the sites hosted therein or supported by them to gather URLs and other information such as the text of pages that the search engine can use in the searches for keywords.

As stated above, the user or vehicle dealer may rely on Internet listings, to track current market values or even market saturation of a specific product or vehicle, as provided by a plurality of sources, such as the manufacturer server 108, the other dealer servers A-M 110, the advertized server 112, the auctioneer server 114, and the like. The crawling unit 122 includes a search engine (not shown) and a plurality of crawlers A-N 202. For the sake of efficiency, each of the crawlers A-N 202 is configured to visit a designated number of targeted Web sites, to seek predetermined vehicle indicators or criteria, and to create a copy of corresponding Web pages for storage in the crawler data store 206, which can be part of the database 132. The predetermined vehicle criteria can include vehicle descriptions or features, price, date of manufacture, merchant, location, optional equipment, mileage, and vehicle condition. The crawlers A-N 202 are also configured to be periodically activated and to constantly search for new or modified products. Alternately, the vehicle dealer may also receive, at the system server 104, vehicle information via random data feeds or dynamic live updates from manufacturers 108, dealers A-M 110, advertisers 112, and auctioneers 114.

For every vehicle found, a history record is created and maintained in the data store 206 to track features, price, shelf or aging time, merchant for each specific vehicle, and other data that may be utilized for efficient market analyses. The vehicle has typically both a retail value and a wholesale value. As such, some of the crawled sites may be tagged as wholesaler sites which are used to help determine the wholesale value of the vehicle.

To better analyze the data collected and stored in the data store 206, a set of parsing units or parsers A and B 210 are configured to parse a defined set of vehicle data. Although only two parsers A and B 210 are discussed and shown, any number of parsers can be utilized simultaneously. If no new data is available or found, the parsers A and B 210 are configured to sleep for a predetermined period of time before awakening for another parsing round, or may be dynamically awakened by the arrival of new vehicle data. The parsers A and B 210 are configured to parse the stored data based on specific patterns and fields of vehicle data. For every pattern or field found, the corresponding relevant data is collected and provided to the data organizing engine 212 to be marked or indexed, dated, source tagged, and stored or organized accordingly.

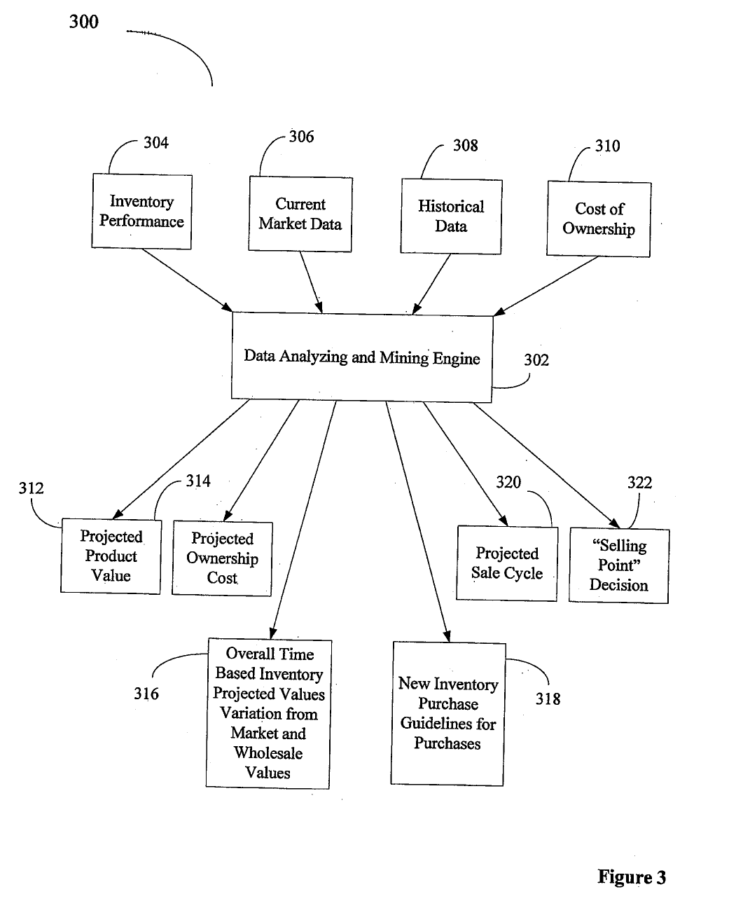

Now referring to FIG. 3, a block diagram 300 schematically illustrates an embodiment of a data analyzing and mining engine 302. Using the above data and the current inventory state of the vehicle dealer, the data analyzing and mining engine 302 can provide the vehicle dealer with real time inventory analysis, historical performance, and projected future performance. The data analyzing and mining engine 302 constantly analyzes the data generated by the crawlers A-B 210 to aggregate the data, provide the desired analysis and update the current state of each of the vehicle records. To perform any analysis, the analyzing and mining engine 302 applies predetermined rules based on a geographical area and relies on at least a number of data sources or other organized data stored by the data organizing engine 212, such as inventory performance source 304, current market data source 306, historical data source 308 and cost of ownership data source 310. The inventory performance source 304 is configured to include and update as needed data related to an inventory performance at the vehicle dealer, profit margins, inventory aging, purchase price, additional vehicles sold (side sales), financing, among others. The current market data source 306 includes data related to the current market conditions, including pricing, inventory aging, number of vehicles on the market, and other market related entities. The historical data source 308 includes data related to historical market analysis and valuation over the market life of the vehicle. The cost of ownership source 310 includes data related to dealership facility cost, and overhead.

The data analyzing and mining engine 302, which can include or be connected to a data mining store 222 and can be triggered by data mining and analyzing applications 224, is configured to analyze data for each unique inventory or vehicle parameter in order to provide guidelines to the vehicle dealer on at least:
A projected inventory value 312 for each vehicle in both retail and wholesale markets. The projected vehicle value 312 is time based and breaks down projected numbers based on a user defined time interval.
A projected vehicle cost 314 relates to the cost of maintaining each inventoried vehicle over time and its impact on profit margins. Some vehicles maintain their values better than others and are cheaper to maintain, while others sell quickly for a faster turnaround.
An overall time based inventory projected variations from both market and wholesale values 316 are determined by evaluating the current and projected inventory losses based on market price drops and market/wholesale valuations of the vehicles. If the dealer is to sell its entire inventory today, or at a future date, the analysis engine 302 would provide the projected loss/gain resulting from the sale transaction.
A new inventory purchase and guidelines for purchases 318 related to guidelines to target specific vehicles for purchasing, and maximum prices to pay in order to maximize profits. The guidelines can be used by dealer buyers in order to purchase vehicles that will provide the best inventory mix.
A projected “Time to Sell” or “Sale Cycle” 320 for each vehicle is determined by analyzing current market demands and inventory levels within the region along with other suitable input factors.
A selling point decision 322 is a set of guidelines, based on the market condition, that are presented to help dealers provide better deals to their clients and “Minimum Selling Price” that managers need to observe in order to maximize profit.

Therefore, the vehicle dealer can perform inventory comparison with the mined data based on any tracked indicators or criteria. As an example, the vehicle dealer, via the analyzing and mining engine 302, can generate a report comparing its inventory aging with the inventory aging within its selling area, or create a “current inventory value” report based on both retail and/or wholesale prices. With the tie in with accounting data (or through other entry methods), inventory water can be quickly computed and compared. The phrasing “inventory water” is a term in the automotive industry that refers to the negative value of the difference between an investment cost of an inventory of vehicles compared to the current wholesale or market value of the inventory of vehicles. In other words, the inventory water can be evaluated by subtracting the current wholesale or market value from the original purchase costs of the vehicles plus any additional costs, such as storing costs, reconditioning costs, etc. . . .

The analyzing and mining engine 302 enables the vehicle dealer to also play “what if” scenarios with the on hand inventory. By having the option of manipulating the inventory mix, the vehicle dealer is able to compute the best inventory mix that provides the most return on investment, along with analysis providing future inventory values. As such, a desirable inventory mix is generated by vehicle analyses that rely on a number of factors such as currently available vehicles for sale, current wholesale inventory, market trends based on historical performances, future vehicle depreciations, vehicle features and conditions, and geographical location. Hence, the vehicle dealer has at its disposal the ability to compute and analyze the effect of inventory aging on revenue and the ability to know when to drop prices or turn the inventory with minimal loss, and to generate corresponding reports.

Therefore, the analysis and mining engine 302 relies on a number of factors such as currently available vehicles for sale, current wholesale inventory, market trends based on historical performances, future vehicle depreciations, and vehicle features and conditions. The analyzing and mining engine 302 uses any or all of these criteria to generate an accurate representation of the inventory current value and future performances. In addition, as the dealer inventory changes, due to new purchases or recent sales, forecasted returns and vehicle values are dynamically provided. The analysis and mining engine 302 is further equipped with a filter that detects and tags erroneous vehicle information, so as to prevent such unwanted information from being analyzed and potentially corrupt generated analyses or reports. Moreover, the analyzing and mining engine 302 is configured to monitor and track accesses by potential clients to the dealer Web site looking for specific vehicles viewable on the on-line inventory. Besides informing the dealer about a viewing frequency for each listed vehicle, such as which vehicles are the most viewed and which vehicles are the least viewed by on-line clients, the tracked on-line client traffic is considered by the data mining and organizing unit 214 when generating analyses for these specific vehicles as well as for inventories. Phone call inquiries about specific vehicles logged by sales personnel are similarly considered and utilized by the data mining and organizing unit 214.

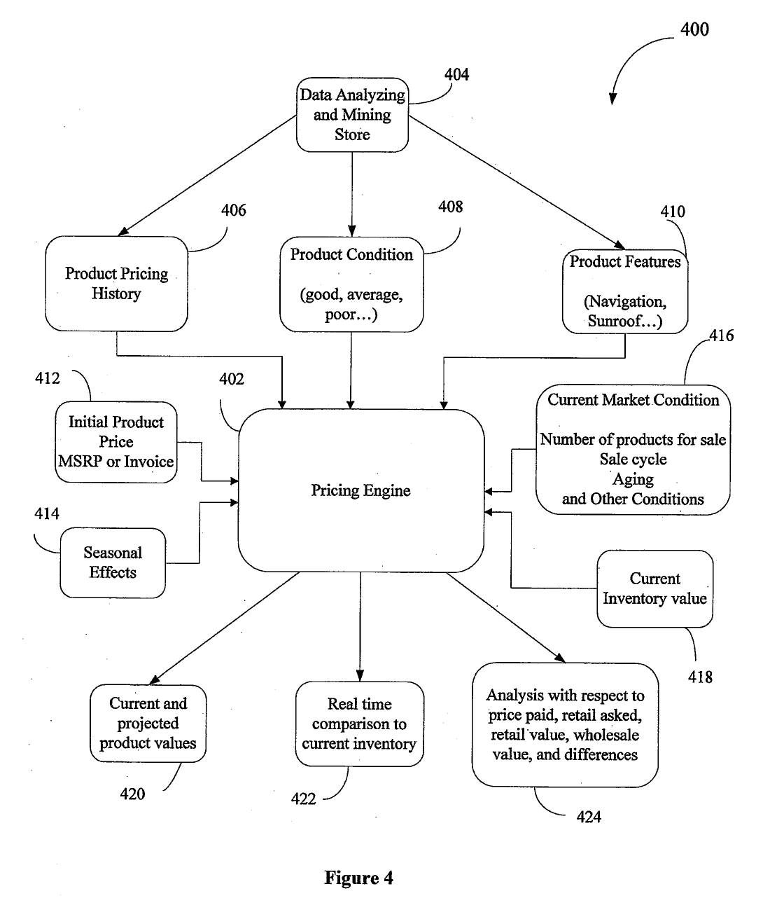

Now referring to FIG. 4, a block diagram 400 illustrates an embodiment of a pricing engine 402. To determine vehicle and inventory values, the price engine 402 relies on at least a number of data sources or other organized data stored by the data analyzing and mining store 404, such as product or vehicle pricing history 406, vehicle age and condition 408 (excellent, good, average, poor, etc. . . . ), vehicle features 410 (navigation, sunroof, etc. . . . ), initial vehicle price 412 (manufacture suggested retail price and invoice), seasonal effects 414, current market conditions 416 (number of vehicles for sale, sale cycle, aging, etc. . . . ), and current inventory value 418.

The pricing engine 402 can be triggered by a command generated periodically or as needed by a user, a pricing application, or by an automatic trigger in response to particular events related sale and purchase of vehicles. The pricing engine 402 is configured to generate current and projected vehicle values 420, real time markets comparison to current inventories 422, analyses with respect to prices paid, retail asked, as well as retail values and wholesale values, and difference between these two values 424.

Therefore, the pricing engine 402 performs analyses required to generate vehicle trends based on the historical records, current values, and the impact on features on the vehicle values. Further, the pricing engine 402 utilizes a proprietary method that uses curve fitting techniques to generate best-fit value functions that are substantially accurate representations of the vehicle values (both retail and wholesale), and utilizes mathematical projections to generate future values of the vehicle as its condition and time changes. The projections are always updated for every vehicle tracked based on newly collected vehicle data, for example from the data mining store 222. Alternately, the pricing engine 402 utilizes other data fitting and predictive tools, such as neural networks. As known to one of ordinary skill in the art, a neural network model is a structure that can be adjusted to produce a mapping from a given set of data to features of or relationships among the data. The neural network model can be adjusted or trained, using a collection of data from a given source as input, typically referred to as the training set. After successful training, the neural network will be able to perform classification, estimation, prediction, or simulation on new data from the same or similar sources. Moreover, other fitting and predictive techniques, such as the one incorporating autoregressive moving average models, can be utilized by the pricing engine 402.

Inventory aging is computed based on at least a couple of factors, either the vehicle is not found on a dealer's inventory (i.e., the vehicle is no longer available for sale), an interface with the dealer indicating that the vehicle has been sold, a customer or dealer personnel entry specifying that the vehicle has been sold, or public records available that are either accessed by the crawlers A-B 210 or directly downloaded through feeds from different institutions. Each vehicle sale price and selling date is tagged and attached to its historical record.

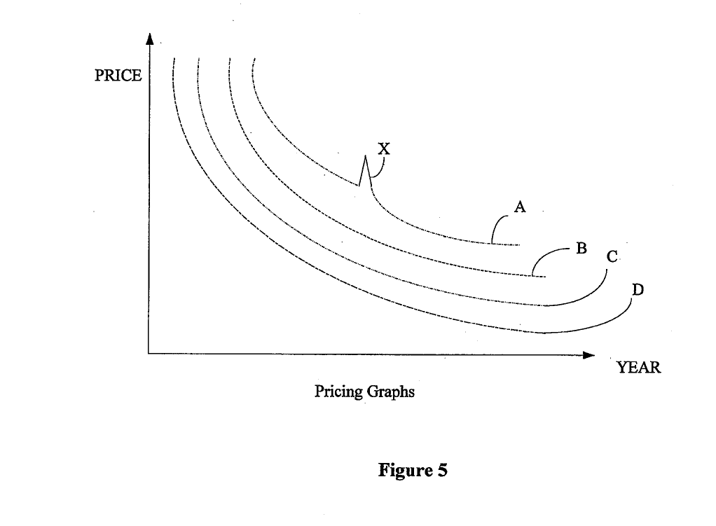

Now referring to FIG. 5, an embodiment of a graph illustrating the price of a vehicle as a function of time and selectable criteria in accordance with the invention. For the sake of simplicity, only curves A through D are illustrated which are representative of 4 vehicles having different features, such types, conditions, and mileages. The curves A through D are purposefully shown as discontinued curves to underscore the fact that they are curve-fitted by interpolation of discrete and even sparse vehicle data collected from at least the data mining store 220. As such, these curves A-D help to generate current prices for a vehicle that substantially match their curve features based on the current vehicle age. Further, these curves A-D can be utilized to generate a future value of a particular vehicle by determining graphically on the corresponding curve a point associated with the desired future date or by evaluating mathematically the function that corresponds to the corresponding curve for the desired future date. By this process, all of the dealer vehicles can have their current values as well as their desired future values determined in a substantially accurate manner. By evaluating the current and future values of every vehicle of a dealer inventory, current and future values of the dealer inventory can also be determined. Of course, the determined values can be either retail or wholesale values. For at least the current inventory, a total inventory water number, which represents the difference between the current investment value of the current inventory and the determined current inventory value, can be evaluated. As shown, on curve A, a price spike X can occur for seasonal reasons. For example, a convertible vehicle can see a price jump during the warm months of the year; just as a 4×4 vehicle can see a price jump during a snowy period of the year.

In summary, the introduced method and system, which include the data mining and analyzing engine 302 and the pricing engine 402, can be utilized to:
Figure out the inventory water based on the current market value (wholesale and retail), and on an analysis or report that provides real time inventory.
Provide analysis comparison of the dealer inventory within a region.
Provide inventory aging analysis and compares it to dealer prices, customer clicks, and page views.
Provide “projected inventory cost” per vehicle based on market analysis, historical data, and cost of storing the car at the dealership (that includes cost of flooring the vehicle, marketing, cost of sale, operations cost, rent . . . ).
Provide a “Offer acceptance” criteria, providing the dealer with a method to either accept the offer on the car or counter offer (for trade ins) based on historical sales, market data, dealer costs, etc. . . .
Provide a projected inventory water analysis.
Provide a projected Aging analysis. That is, how long it will take to sell the vehicle based on the time of purchase, seasonality, market, etc. . . .
Provide a global pricing view of all matched vehicle in a region.
Provide from the listing side, a connection between dealers and consumers by informing the dealer of consumers looking for specific cars currently in inventory.
Provide guidelines on what cars to buy and maximum purchase price in order to maintain current and future positive inventory values.

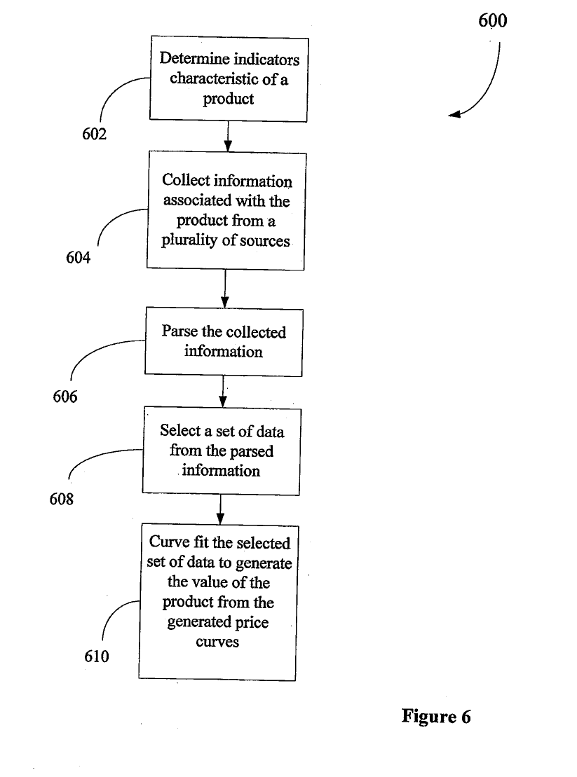

Now referring to FIG. 6, an embodiment 600 of a method for evaluating current and future prices of vehicles in accordance with the invention is shown. The method is configured to generate a value of a product or vehicle by aggregating vehicle information collected from a plurality of sources in a networked computer system. The method determines indicators for the vehicle, at step 602, and collects information associated with the product from one or more of the plurality of sources, at step 604. The method further parses the collected information based on the indicators, at step 606, and selects a set of data from the parsed information, at step 608. The method then curve-fits the parsed information based on market parameters to generate the value of the vehicle, within step 610.

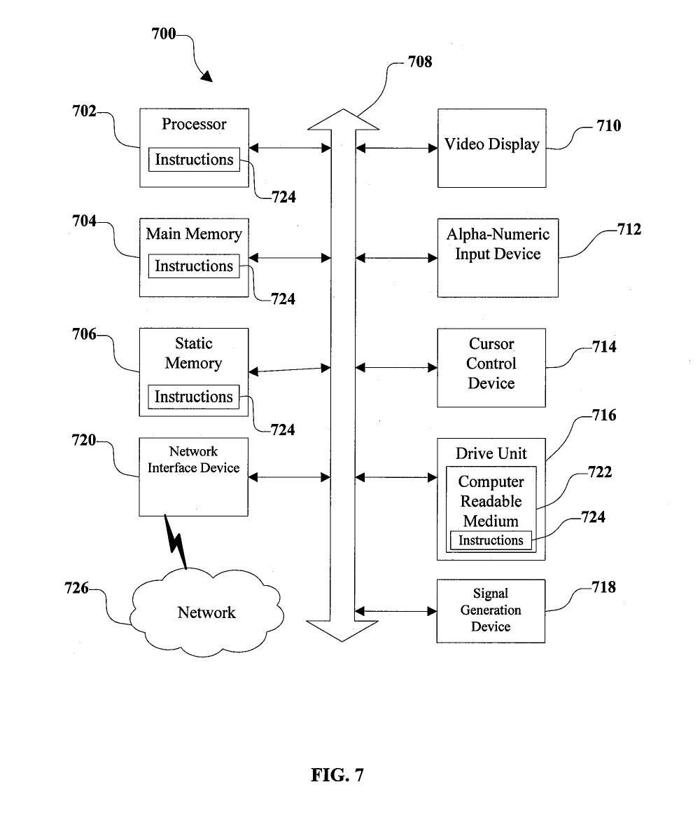

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

It is therefore intended that the foregoing detailed description be regarded as illustrative rather than limiting, and that it be understood that it is the following claims, including all equivalents, that are intended to define the spirit and scope of this invention.

1. A method of generating a value of a product, the method comprising the steps of:
determining indicators representative of manufacturing characteristics of the product;
collecting information associated with the determined indicators from one or more of a plurality of sources in a networked computer system;
parsing the collected information based on predetermined parameters;
selecting a set of data from the parsed information; and
generating the value of the product based on the selected set of data.

2. The method of claim 1, wherein the indicators comprise at least one of a manufacturer name, a model, and a type.

3. The method of claim 1, wherein the parameters comprise at least one of a product age, a product condition, and a product feature.

4. The method of claim 1, further comprising:
generating values for each of a plurality of products that forms an inventory.

5. The method of claim 4, further comprising:
generating an analysis comparison of the inventory within a geographical region.

6. The method of claim 4, further comprising:
determining a time to sell for the product based on at least one of a time of purchase of the product, seasonality, an inventory level of the product within the region.

7. The method of claim 5, further comprising:
determining projected inventory costs of the product based on market analysis, historical data, and cost of storing the product.

8. The method of claim 7, further comprising:
generating criteria for an offer acceptance to sell the product based on at least one of historical sales, market demands, and the inventory cost of the product.

9. The method of claim 7, further comprising:
generating guidelines on which products to purchase and respective maximum purchase prices in order to maintain current and future positive inventory values.

10. The method of claim 1, wherein the value of the product is either a retail value or a wholesale value.

11. The method of claim 1, wherein the step of generating the value of the product comprises:
curve-fitting the collected data to generate best-fit value curves or functions; and
deriving the value of the product from the generated curves or functions.

12. The method of claim 1, wherein the step of generating the value of the product comprises:
establishing a neural network model from historical data; and
generating the value of the product by plugging the collected data into the neural network model.

13. The method of claim 11, wherein the generate value of the product is either a current and future value of the product, provided via interpolations and extrapolations, respectively.

14. The method of claim 1, wherein the step of collecting information comprises:
triggering at least one crawler to visit the plurality of sources to locate products characterized by similar indicators.

15. The method of claim 1, wherein the determined indicators are from the group consisting of at least one of a manufacturer name, a model, a type, and a feature.

16. The method of claim 14, wherein the networked computer system is the Internet and the at least one crawler is a Web crawler.

17. The method of claim 1, wherein the generation of the value of the product is based on inventory comparison with that of at least one of the plurality of sources.

18. A computer readable medium comprising instructions which when executed by a computer system causes the computer to implement a method for generating a value of a product, the method comprising the steps of:
determining indicators representative of manufacturing characteristics of the product;
collecting information associated with the product from one or more of the plurality of sources in a networked system;
parsing the collected information based on predetermined parameters;
selecting a set of data from the parsed information; and
generating the value of the product based on the selected set of data.

19. A system for performing a method for generating a value of a product, the method comprising the steps of:
at least one processor programmed to determine indicators representative of manufacturing characteristics of the product;
at least one processor programmed to collect information associated with the located product from one or more of the plurality of sources in a networked system;
at least one processor programmed to parse the downloaded information based on predetermined parameters;
at least one processor programmed to select a set of data from the parsed information; and
at least one processor programmed to generate the value of the product based on the selected set of data.
